(19) United States
(12) Patent Application Publication
(10) Pub. No.: US 2010/0060097 A1
(43) Pub. Date: Mar. 11, 2010

(54) Shape adaptive generator motor

(76) Inventor: Scott Lewis Peterson, Bellingham, WA (US)

Correspondence Address: STUART WEST, P.E.;WEST & ASSOCIATES, A PL, 1255 TREAT BLVD 3RD FLOOR, WALNUT CREEK, CA, 94597, US

(21) Appl. No.: 12/583,930

(22) Filed: Aug. 28, 2009

Related U.S. Application Data
(60) Provisional application No. 61/096,283, filed on Sep. 11, 2008.

(51) Int. Cl. H02K 3/00; H02K 53/00

(52) U.S. Cl. 310/179; 415/916

(57) ABSTRACT

A motor/generator system that can be controlled internally based on external power-generating needs or in response to operating parameters. The system can be controlled manually by a user to select desired power-generating needs. The system can also be controlled by an algorithm taking into consideration parameters such as vehicle velocity and potential to predict speed, braking, acceleration or deceleration. In the motor/generator, stator plates can be moved by linear controllers in response to these external inputs to vary the amount of required power, creating an on-demand charging system that can efficiently transfer power and extend the life of the system.

### FIELD OF THE INVENTION

The present disclosures relates to the field of motors and generators, specifically generators harvesting energy and converting it to power.

In recent years, several new types of motors and generators have been developed in an effort to improve efficiency. In particular, as hybrid, electric (EV), and fuel-cell vehicles have gained more attention, the need has risen to create smaller and more powerful motors.

A major drawback of alternative vehicles that exist today is that their primary recharging systems are external (other than minimal recharging created by regenerative braking in some vehicles). In other words, EV's need to be plugged-in, hybrids internal combustion engine usually kicks in after a short distance, and infrastructure for fuel-cell hydrogen fueling stations are extremely limited. As a result, manufacturers are working on integrating the charging and propulsion systems. However, achieving compatibility and balance between power, range, and infrastructure can be a challenge for alternative powered vehicles.

What is needed is an on-board charging system that can use the motion of a vehicle to power the electrical system while still being efficient.

### BRIEF DESCRIPTION OF THE DRAWINGS

FIG. 1 shows a side view of one embodiment of the present device.

FIG. 2 shows a front view of one embodiment of a generator of the present device.

FIG. 3 shows a front view of another embodiment of the present device.

FIG. 3a shows a side view detail of a controller in an embodiment of the present device.

FIG. 3b shows a perspective view of the embodiment of the device shown in FIG. 3.

FIG. 3c shows a side view of a dual-controller in an embodiment of the present device.

FIG. 4 depicts a side view detail of the generator in an alternate embodiment of the device.

### DETAILED DESCRIPTION

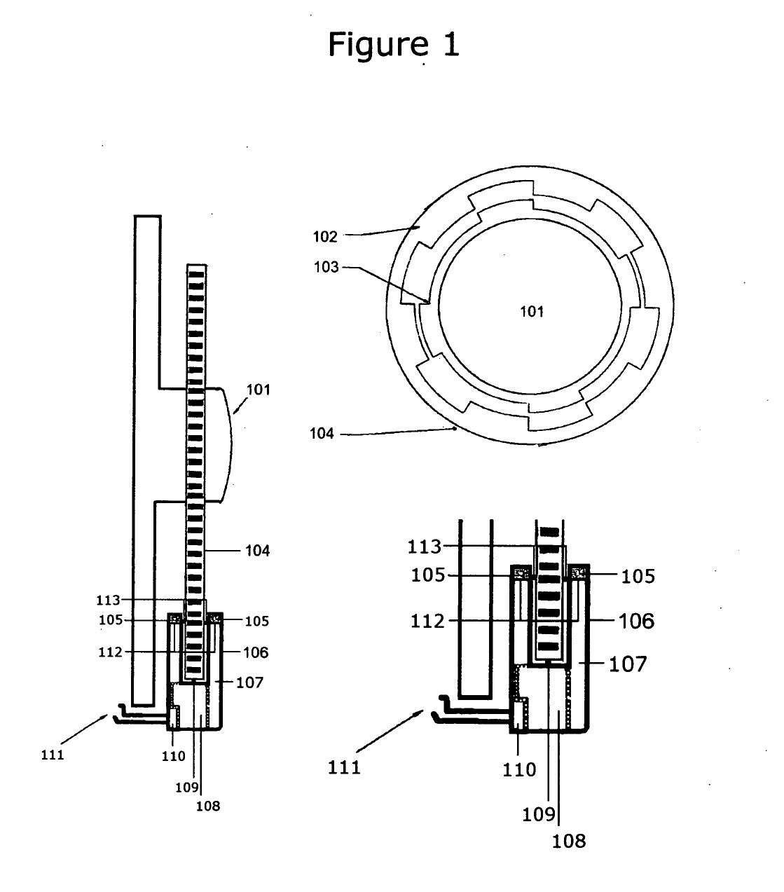

FIG. 1 depicts a side view of one embodiment of the present device. In some embodiments, as shown in FIG. 1, the present device can comprise a rotating generator 104 and a controller 106. A generator 104 can have a rotor 103 that can be attached to a hub 101, and an exterior shell that can be fixed to a controller 106.

A stator 102 and rotor 103 can have an interior plurality of indentations and protrusions that can serve as poles. The controller 106 can lock onto generator 104 with a plurality of dual purpose quick-release snap fittings 112 containing system control electrical and electronic input/output devices.

A controller 106 can convert the energy flow into streamable electricity and flow it to the electrical control system using capacitors 107, seed coils 105, transfer bars 112, and regulators 108. A controller 106 can further comprise a seed coil 105 that can be first energized by electrical flux from a generator 104. A seed coil 105 can then electrify a transfer bar 112. An embedded card 110 and a RF transmitter 109 are part of a real-time system to act upon a generator 104. Stabilizer lines 111, which can be flexible, can connect a controller 106 to a vehicle's electrical control system from a generator 102.

A controller 106 utilizing an embedded card 110 as part of a real-time system to act upon a generator 104 and a controller 106. In some embodiments of the present device, real-time deadlines and operations can be accomplished in an inverse peer-to-peer manner. While the controller can over-ride instructions from the generator, the generator can perform functions autonomously while monitored by controller so that function speed is optimized.

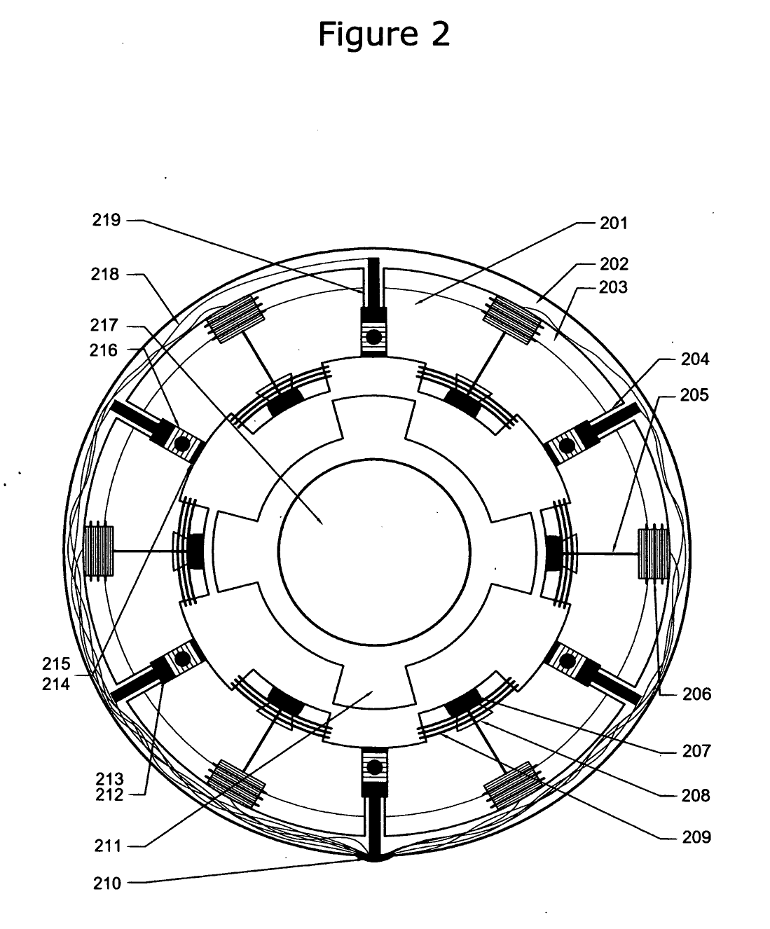

In some embodiments of the present device, as shown in FIG. 2 control of on/off and regulation of heat and power in a motor/generator can be accomplished by a shape-adaptive mechanism. Although depicted in FIG. 2 as a 3-phase motor with a four-pole rotor and a six-pole stator, the motor can have any other known and/or convenient configuration.

A rotational generator 104 can have an inner and outer housing allowing expansion 203. This space of any known and/or convenient geometry can exist between these housings to allow for radial expansion and contraction of a stator 201. A rotor 211 can be connected to a hub 217.

A stator 201 can be comprised of a plurality of radially separated plates 204. Although depicted in FIG. 2 as having six plates 204, a stator 201 can have any known and/or convenient number of plates 204. Expansion shields 214 can be housed in expansions shield pockets 215, which can be located at the interior edges of seams of plates 204 to cover the seams when open.

A plate 204 can have a linear motion controller 219 positioned in a substantially central location on a surface of a plate 204. A linear motion controller 219 can employ a ball-and-screw mechanism, as shown in FIG. 2 or any other known and/or convenient mechanism. A linear motion controller 219 can also further comprise of a rechargeable battery 212 and an embedded card 213. At least one wire 218 can connect a linear motion controller 219 to an output/input device 210.

To operate the embodiment shown in FIG. 2, a user can switch on a generator 104 via a dashboard control system or any other known and/or convenient device. An embedded card 213 can analyze speed, temperature, braking, acceleration/deceleration, and/or any other desired parameters. This data is fed into an algorithm that can best determine the pole position in a generator 104. When system data indicates a “normal” range, as determined by an embedded card 213, the plates 204 can be moved via linear motion controllers 219 to a position of maximum charge for a 3-mm air gap, for example. However, if less than optimal conditions are detected, plates 204 can be moved to create a 3.04-mm, or any other known and/or convenient spacing between the rotor and stator poles, for example. Assuming that a 3-mm air gap is optimal for harvesting the maximum amount of energy in a generator 104, any air gap greater than 3-mm can yield less energy, but prevents heat build-up and frequent on/off cycling, which can smooth the waveform, and, therefore power efficiency of a motor.

In a “full-on” position, as depicted in FIG. 2, plates 204 can be in the maximum radially inward position, with no gaps between the plate seams, to give an air gap on 3-mm, for example. When a generator 104 is running at less than “full-on” capacity, plates 204 can be moved radially outward such that gaps between plate seams would open up. In this situation, expansion shields 214 can slide out of expansion-shield pockets 215 and be attached to neighbor poles to shield these gaps. When a generator 104 is in an “off” position, creating a 7-mm air gap, for example, no power can be generated and expansion shield 214 can be fully deployed if plates are fully deployed outward. When “full-on operation resumes, plates 204 can move radially inward to close the gaps, while expansion shields 214 can slide back into expansion-shield pockets 215.

By controlling power at the source, i.e. flux levels directly in the generator, if desired, a user can choose various power-generating need/settings. For example, using lower desired range preset algorithms, a generator 104 can deactivate after a recharging goal is achieved (i.e. charging on-demand), thus extending the life of the device.

An algorithm can control a generator 104 by using parameters such as potential, velocity and geometric progression to predict speed, braking, acceleration, or deceleration similar to that in anti-lock braking systems (ABS). The success of a generator 104 can be predicated on the waveform of the power output. An algorithm's primary function can be to matched against a waveform preset allowing optimal waveforms by prediction of the rotation of a hub 217 so that an algorithm can then signal linear motion controllers 219 to radially move plates 204, and therefore, stator poles, to accomplish a desired task, that is to deliver clean and usable power to a controller 104 and subsequent output to batteries or directly to the electrical system.

The embodiment depicted in FIG. 2, the device can include a primary/secondary coil wire 205, a primary coil 209, secondary coil 206, a transfer bar 207, and a plate movement track 208.

The transfer bar 207 can be located proximate to the edge of a stator plate 204 and can be coupled with a plate movement track 208 adapted to allow radial, rectilinear motion of the transfer bar relative to the device. In some embodiments, any desired number of transfer bars 207 can be incorporated.

A primary coil 209 can be coupled with the stator plate and located adjacent to the transfer bar 207 and the transfer bar 207 can be coupled with a secondary coil 206 via a primary/secondary coil wire 218. In some embodiments, the secondary coil 206 can be located in any other known and/or convenient location within the device and/or may be coupled in any other known and/or convenient manner.

Introduction of the primary and secondary coils 209 206 and transfer bar 207 can result in generation of a greater amount of heat than would be anticipated from the device. The configuration can increase the energy generated by the device at the source and increase the energy supplied to the controller 104. Heat generation can be mitigated and/or controlled by appropriate control of the stator plates 201 and design factors including the number of poles including primary and/or secondary coils 206 209. In operations, the device can include any number of desired paired and/or unpaired primary and/or secondary coils 206 209 which can be located in any desired and/or convenient location within the device.

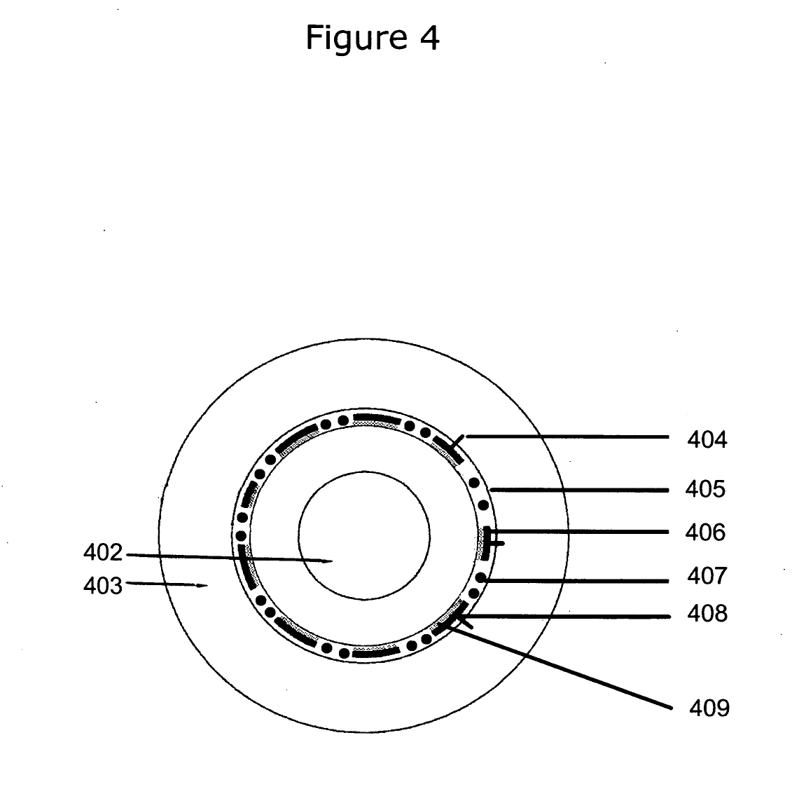

Depicted in FIG. 4, electrical generation can be switched on/off by radio-frequency (RF) receiver 409 from signal sent by controller 104 deactivating rotor rotation by slip-ring 405 (bearings 407) via controller 408. While hub 402 speed is constant, rotor 403 rotation works with toggle 404 (depicted engaged) by tilt mechanism 406 or any other known and/or convenient mechanism.

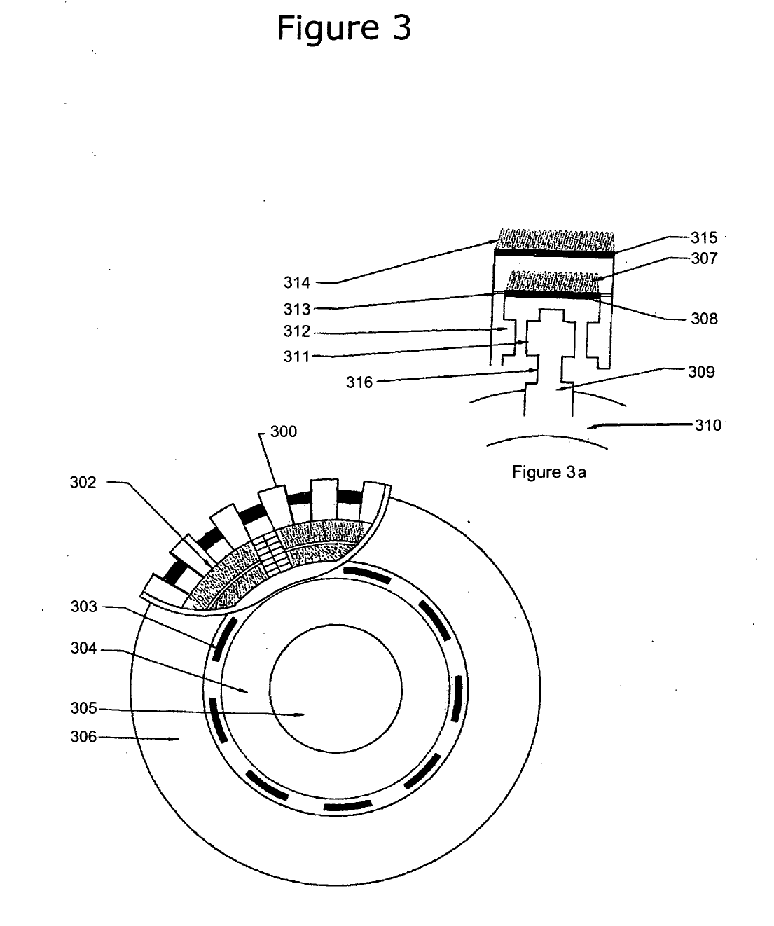

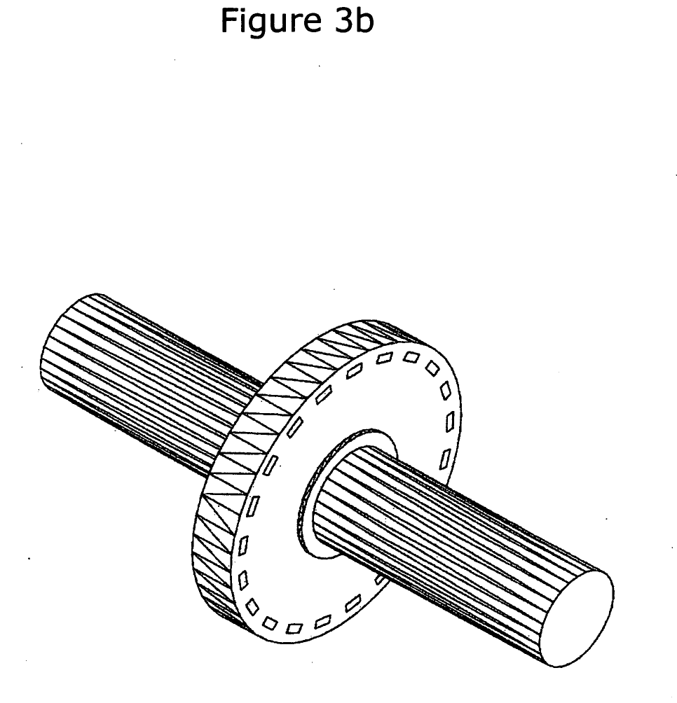

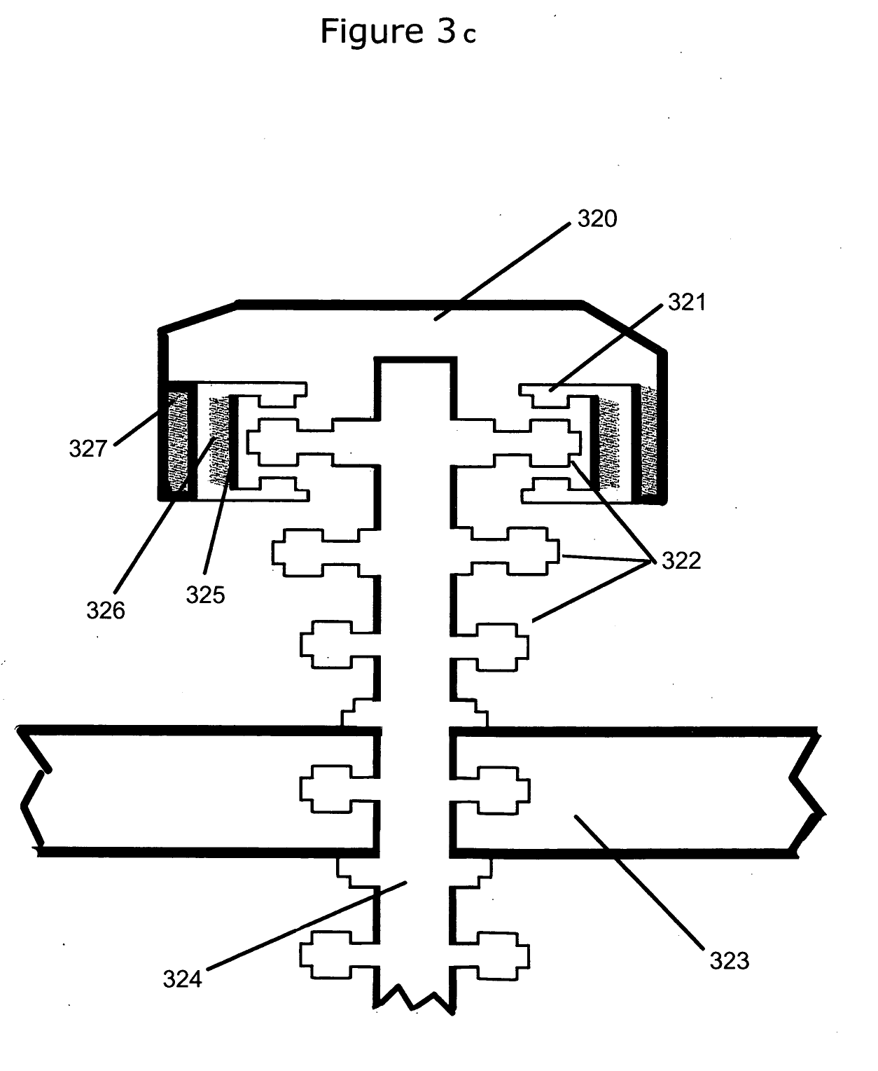

FIG. 3 depicts a front view of another embodiment of the present device. In this embodiment, which can be used in circumstances, where limited space is not an impediment, such as in some industrial applications, an idler rim 306 can be attached to a spinning axle or hub 305 via a collar 304. Idler rim 306 can have a plurality of indentations on the outer perimeter edge or one or both surfaces of an idler rim 306 with attached rotor poles 303. Heat vents 300/302 assist cooling.

Depicted in FIG. 3a side view detail is a single rotor/stator embodiment 309 on the idler rim perimeter edge 310. In a vehicular application, only one side of an idler rim 310 or the idler rim perimeter edge 310 (depicted) are available where space may be limited. A linear motion controller 308 on track 313 can regulate the optimal distance (air gap) of the stator poles 312 from rotor poles 311 formed by indentations 316 in an rotor pole 309. A seed coil 307 than can be first energized by electrical flux from rotor poles 311 passing through stator poles 312. A seed coil 307 can then electrify a transfer bar 315, which can ramp the wattage potential approximately by a factor of 10 when a secondary coil 314 is energized. A secondary coil 314 can then generate electricity.

FIG. 3c side view depicts a detail drawing of an integrated dual-sided controller/generator 320. In dual embodiments, a plurality of stators can be on both sides of an idler rim 324. A plurality of rotor posts 322, on each side of an idler rim (wheel) 324, can be directly fixed, attached, or part of an idler rim 324. Stator pole 321, depicted in a full-outward position or maximum air gap via linear motion controller 325. Secondary coil then streams electricity at no or minimal levels.

In use, the embodiments shown in FIG. 3 operates similarly to that shown in FIGS. 1 and 2. An algorithm can signal linear motion controllers 325 to regulate power. By increasing or decreasing the air gap and regulating the distance between stator poles 321 and rotor poles 322, power generation efficiencies and deficiencies regulate the power efficiencies demanded by the integrated controller caliper 320.

Although the invention has been described in conjunction with specific embodiments thereof, it is evident than many alternative, modifications, and variations will be apparent t those skilled in the art. Accordingly, the invention as described and hereinafter claimed intended to embrace all such alternative, modifications and variations that fall within the spirit and broad scope of the claims.

What is claimed is:

1. A motor/generator, comprising:
a rotor attached to a hub;
a stator connected to a controller, wherein said stator further comprises an exterior that fit with corresponding parts in said controller to lock said stator in a fixed position;
wherein said controller further comprises a seed coil that after first being energized by electrical flux electrifies a transfer bar, a secondary coil that generates electricity, a regulator coupled with a capacitor that converts the electricity into a streamable power flow to at least one electrical storage or transfer device, and an embedded card;
a plurality of radially segmented plates;
expansion shields housed in expansion shield pockets at the interior edges of seams of said plates to cover the seams when open;
a plurality of linear motion controllers positioned in a substantially central location on a surface of said plates, wherein said linear motion controllers further comprise a rechargeable battery and an embedded card;
at least one wire connecting said linear motion controller to an output/input device. A slip ring attached to the rotor commanded by the controller by an RF signal can deactivate spinning of rotor when energy transference requires cutoff.

3. A motor/generator, comprising:
an idler rim attached to a spinning axle, said idler rim having a plurality of indentations on the outer perimeter region of at least one surface of said idler rim that form rotor poles;
a caliper housing a plurality of controllers, wherein two side-by-sided controllers form a single unit on each side of said idler rim that form rotor poles;
a caliper housing a plurality of controllers, wherein two side-by-side controllers form a single unit on each side of aid idler rim;
a stator having a plurality of stator poles, wherein said controller is fixed to said stator;
wherein said controller further comprises a seed coil that when first energized by electrical flux from said indentations passing through said stator poles in said stator, a seed coil that electrifies a transfer bar, a secondary coil that generates electricity, and a linear motion controller that regulates the optimal distance of said stator poles from said rotor poles.
a plurality of linear motion controllers positioned in a substantially central location on a surface of said plates, wherein said linear motion controllers further comprise a rechargeable battery and an embedded card;
at least one wire connecting said linear motion controller to an output/input device.

3. A switched reluctance motor, comprising:
an idler rim attached to a spinning axle, said idler rim having a plurality of indentations on the outer perimeter region of at least one surface of said idler rim that form rotor poles;
a caliper housing a plurality of controllers, wherein two side-by-side controllers form a single unit on each side of said idler rim;
a stator having a plurality of stator poles, wherein said controller is fixed to said stator;
wherein said controller further comprises a seed coil that when first energized by electrical flux from said indentations passing through said stator poles in said stator, a seed coil that electrifies a transfer bar, a secondary coil that generates electricity, and a linear motion controller that regulates the optimal distance of said stator poles from said rotor poles.
